(19) United States
(12) Patent Application Publication
(10) Pub. No.: US 2022/0004882 A1
(43) Pub. Date: Jan. 6, 2022

(54) LEARNING APPARATUS, METHOD, PROGRAM AND INFERENCE APPARATUS

(71) Applicant: KABUSHIKI KAISHA TOSHIBA, Tokyo (JP)

(72) Inventors: Teguh BUDIANTO, Yokohama (JP); Tomohiro NAKAI, Kawasaki (JP)

(73) Assignee: KABUSHIKI KAISHA TOSHIBA, Tokyo (JP)

(21) Appl. No.: 17/186,624

(22) Filed: Feb. 26, 2021

(30) Foreign Application Priority Data
Jul. 1, 2020 (JP) 2020-114307

(51) Int. Cl. G06N 3/08; G06N 3/04

(52) U.S. Cl. CPC G06N 3/088; G06N 3/0454

(57) ABSTRACT

According to one embodiment, a learning apparatus includes a first compressor, a generator, a second compressor, a discriminator and an updating unit. The first compressor generates a first latent variable from a sample using a first network. A generator generates a reconstruction sample from the first latent variable using a second network. The second compressor generates a second latent variable from the reconstruction sample using a third network. The calculator calculates a distance in a latent space between the first and second latent variables. The discriminator outputs a discrimination score using a fourth network. The updating unit trains the first to fourth networks based on the discrimination score and train the third network based on the distance.

### CROSS-REFERENCE TO RELATED APPLICATIONS

This application is based upon and claims the benefit of priority from Japanese Patent Application No. 2020-114307, filed Jul. 1, 2020, the entire contents of which are incorporated herein by reference.

### FIELD

Embodiments described herein relate to a learning apparatus, method, program and an inference apparatus.

### BACKGROUND

The anomaly detection technology in general is applied for the purpose separating anomalous behaviour from normal data distribution. In recent real-world applications of anomaly detection, a highly required method is being able to distribute a complex and high-dimensional data.

In recent days, Generative Adversarial Networks (GAN) is widely adopted for the anomaly detection. However, in general, GAN-based anomaly detection shows limitation on the normal samples reconstruction which gives high reconstruction error among inliers samples (also referred to as “bad cycle consistency”). The large distance of original data sample to its reconstruction both for normal and anomaly samples causes the difficulties on anomaly measurement. This creates no separation between normal and anomaly samples. Therefore, the anomaly detection performance is degraded significantly by the bad cycle consistency.

### BRIEF DESCRIPTION OF THE DRAWINGS

FIG. 1 is a block diagram of a learning apparatus according to a first embodiment;

FIG. 2 is a block diagram of a network model trained by the learning apparatus according to the first embodiment;

FIG. 3 is a flowchart for operation of the learning apparatus according to the first embodiment;

FIG. 4 is a block diagram of a network model trained by the learning apparatus according to the first embodiment;

FIG. 5 is a block diagram of a network model trained by the learning apparatus according to a modification of the first embodiment;

FIG. 6 is a block diagram of an inference apparatus according to a second embodiment;

FIG. 7 is a block diagram of a network model used by the inference apparatus according to the second embodiment;

FIG. 8 is a flowchart for operation of the inference apparatus according to the second embodiment;

FIG. 9 shows an example of an inference result of target data sample executed by the inference apparatus;

FIG. 10 shows an example of evaluation result of target data sample executed by the inference apparatus; and

FIG. 11 is a block diagram of hardware component of the learning apparatus and the inference apparatus.

### DETAILED DESCRIPTION

In general, according to one embodiment, a learning apparatus includes a first compressor, a generator, a second compressor, a calculator, discriminator and updating unit. A first compressor is configured to generate a first latent variable from a data sample using a first network, the first latent variable representing a feature of the data sample in latent space. A generator is configured to generate a reconstruction data sample from the first latent variable using a second network. A second compressor is configured to generate a second latent variable from the reconstruction data sample using a third network. A calculator is configured to calculate a distance in the latent space between the first latent variable and the second latent variable. A discriminator is configured to output a discrimination score relating to a discrimination of the data sample and the reconstruction data sample using a fourth network. An updating unit is configured to train the first to fourth networks based on the discrimination score and train the third network based on the distance until achieving optimization.

In the following embodiments, it is assumed that a learning apparatus generates a GAN-based network model for an anomaly detection system and an inference apparatus performs an anomaly detection. Anomalies are defined as patterns that do not satisfy a standard of particular behaviour. In term of data mining and statistics, anomalies lie as outliers of the majority data from normal region. Approaches for anomaly detection is examined in many different fields; such as healthcare, video surveillance, and images analysis.

In the following, a learning apparatus, method, program and an inference apparatus according to embodiments of the present disclosure will be described in detail with reference to the drawings. In the explanation of the embodiments below, for brevity, each structural element will be explained once.

### First Embodiment

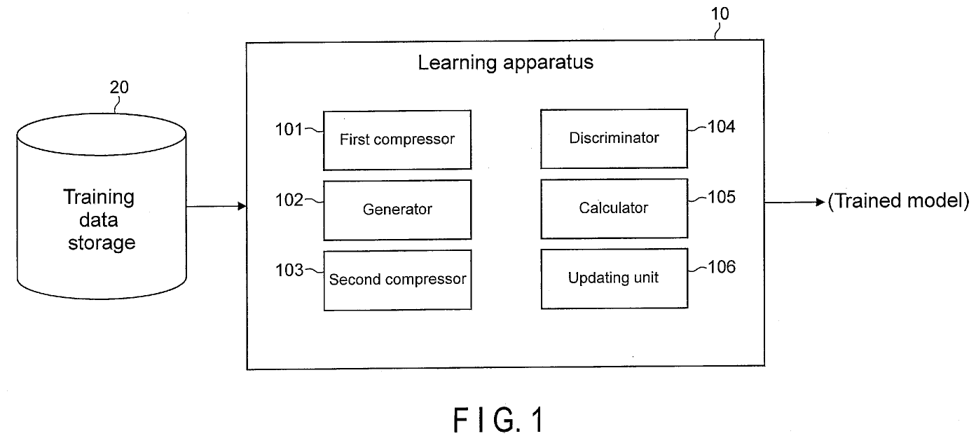

FIG. 1 illustrates a block diagram of a learning apparatus according to a first embodiment.

The learning apparatus 10 according to the first embodiment obtains a plurality of training data samples from a training data storage 20 and trains a network model using a training data.

The training data storage 20 stores the plurality of training data samples. In the first embodiment, a normal value data (hereinafter referred to as “real data sample”) is stored as the training data for the purpose of generating a trained model for anomaly detection. The real data sample is assumed to be a multi-dimensional vector with a plurality of elements. For example, if the real data sample is an image data, it will be a vector data with pixel values as one element. The real data sample may be with or without noise. The training data storage 20 is assumed to be an external server being connected to the learning apparatus 10; however, it may be included in the learning apparatus 10.

The learning apparatus 10 according to the first embodiment includes a first compressor 101, a generator 102, a second compressor 103, a discriminator 104, a calculator 105 and an updating unit 106.

The first compressor 101 generates a first latent variable from the real data sample using a first network. The first latent variable is a value corresponding to a point on a latent space when the real data sample existing in a data space is mapped to the latent space. The first latent variable is, for example, a multi-dimensional vector with a plurality of elements, that represents features of the real data sample.

The generator 102 generates a reconstruction data sample from a random variable in the latent space or the first latent variable generated by the first compressor 101 using a second network. The reconstruction data sample is data which maps a latent variable existing in the latent space to the data space.

The second compressor 103 generates a second latent variable from the reconstruction data sample generated by the generator 102 using a third network. The second latent variable is similar to the first latent variable, the second latent variable corresponds to the point on the latent space when the reconstruction data sample existing in the data space is mapped to the latent space, and is a multi-dimensional vector having a plurality of elements.

The discriminator 104 discriminates the real data sample and the reconstruction data sample using a fourth network and generates a discrimination score based on difference of features.

The calculator 105 calculates the difference between the first latent variable and the second latent variable. Here, a cost distance between the first latent variable and the second latent variable is calculated. The method of calculating the difference is not limited to distance, and may be a method which quantitatively calculates the difference between the first latent variable and the second latent variable.

The updating unit 106 repeatedly updates the first network, the second network, the third network, and the fourth network based on the discrimination score generated by the discriminator 104 and in order to optimize each network. The updating unit 106 repeatedly updates the third network based on the cost distance generated by the calculator 105.

Subsequently, the training of each network is terminated when a predetermined optimization condition is satisfied. As a result, the trained model is generated.

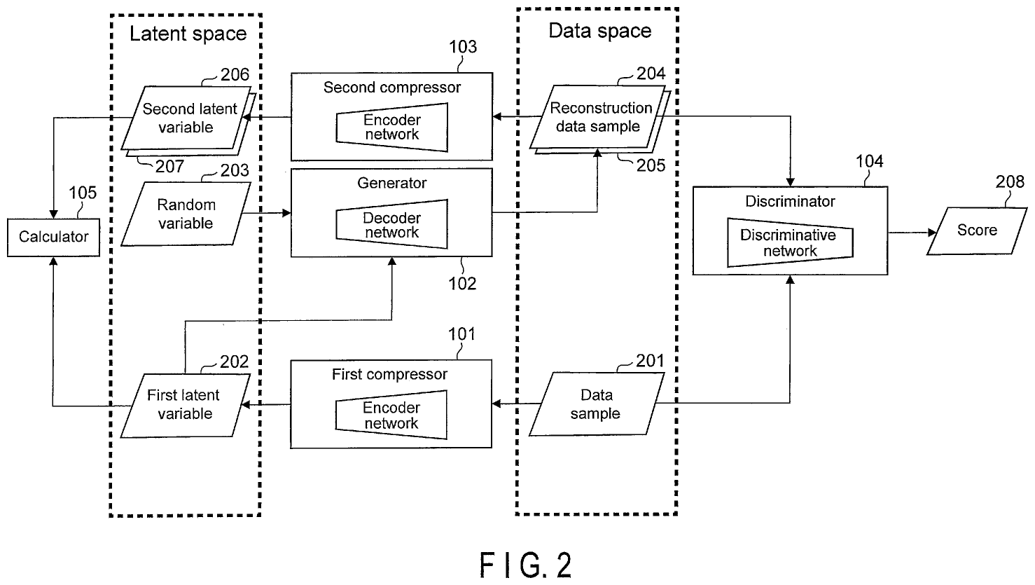

Next, a network model for training using the learning apparatus 10 according to the first embodiment is explained with reference to FIG. 2.

The network model shown in FIG. 2 is a model based on Generative Adversarial Network (GAN).

The first compressor 101 uses an encoder network as the first network. The generator 102 uses a decoder network as the second network. The second compressor 103 uses a separate encoder network different from the first network as the third network. The discriminator 104 uses a discriminative network as the fourth network.

The encoder network can be a network configuration which maps the feature of data existing in the data space on the latent space. For example, if the data is an image, the encoder network can be a network configuration which generates a point on the latent space expressing the feature of the image. Further, the decoder network can generate a data existing on the data space from a point on the latent space. For example, the decoder network can be a network configuration which generates an image from the point on the latent space. The discriminative network can be a network configuration which discriminates if the data to be input is a real data sample (real) or a reconstruction data sample (fake) generated by the generator 102.

Each of the above networks can be a multilayer neural network used in a general GAN or a Deep Convolutional GAN (DCGAN). More specifically, each network may have any kind of configuration such as Deep Convolutional Neural Network (DCNN), Recurrent Neural Network, Recursive Neural Network, Branching Neural Network, Merging Neural Network etc. In addition, each network may be a combination of the above, and may have any kind of interlayer structure such as including a layer of Recurrent Neural Network in the DCNN.

In the present embodiments, a general GAN having the generator 102 and the discriminator 104 is expanded to use a network model including two encoder networks which are respectively trained by the first compressor 101 and the second compressor 103.

The first compressor 101 obtains real data sample 201 as training data from, for example, training data storage 20. In the first compressor 101, the obtained real data sample 201 is input to the encoder network, the real data sample 201 is encoded and a first latent variable 202 is outputted. Hence, the first latent variable 202 where the real data sample 201 is mapped on the latent space is obtained as a point of latent variable indicating the features of the real data sample 201. The first latent variable 202 is expressed as the multi-dimensional vector indicating the features of the real data sample 201.

The generator 102 respectively receives the first latent variable 202 from the first compressor 101 and a random variable 203 which is noise (z) provided to the generator 102. In the generator 102, the latent variable is decoded by inputting the first latent variable 202 and the random variable 203 existing in the latent space to the decoder network, and the reconstruction data sample is outputted. Here, the reconstruction data sample 204 corresponding to the first latent variable 202 and the reconstruction data sample 205 corresponding to the random variable 203 are respectively outputted.

The second compressor 103 receives the reconstruction data samples 204 and 205 from the generator 102. In the second compressor 103, by inputting the reconstruction data samples 204 and 205 into the encoder network, the reconstruction data sample 204 is encoded and the second latent variable 206 is outputted, and the reconstruction data sample 205 is encoded and the second latent variable 207 is outputted.

Thus, the second latent variables where the reconstruction data samples are mapped on the latent space are obtained as points of the latent variables representing the features of the reconstruction data samples. The second latent variables 206 and 207 is represented as the multi-dimensional vector showing the features of the reconstruction data sample.

The calculator 105 respectively receives the first latent variable 202 from the first compressor 101 and the second latent variable 206 from the second compressor 103. The calculator 105 calculates the cost distance between the first latent variable 202 and the second latent variable 206. As one of the cost distance, for example, the Manhattan distance is calculated on the latent space.

The discriminator 104 respectively receives real data sample 201 input to the first compressor 101 from the training data storage 20 and reconstruction data samples 204 and 205 from the generator 102. The discriminator 104 discriminates if the inputted data is a real data or a fake data by inputting the real data sample 201 and reconstruction data samples 204 and 205 into the discriminative network. As a result, the discriminator 104 outputs the discrimination score 207.

The discriminator 104 may discriminate if the inputted data is the real data or the fake data by inputting the real data sample 201 and reconstruction data sample 205 generated by random variable.

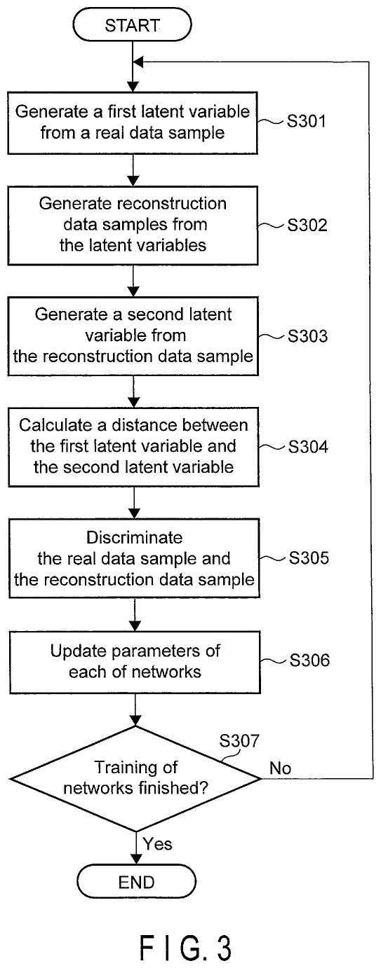

Next, a training process of the learning apparatus 10 according to the present embodiment is explained with reference to the flowchart of FIG. 3.

In step S301, the first compressor 101 obtains the real data sample which is the training data, encodes the real data sample to generate the first latent variable.

In step S302, the generator 102 decodes the random variable and first latent variable, and generates reconstruction data samples respectively.

In step S303, the second compressor 103 encodes the reconstruction data samples, and generates the second latent variables.

In step S304, the calculator 105 calculates the cost distance between the first latent variable and the second latent variable. Here, the second latent variable is generated the reconstruction data sample generated from the first latent variable.

In step S305, the discriminator 104 discriminates the real data sample and the reconstruction data sample, and generates a discrimination score.

The order of the processes of steps S303 and S304 and the process of step S305 may be changed or may be performed in parallel.

In step S306, the updating unit 106 updates each parameter of the first network, the second network, the third network, and the fourth network and optimizes each network so that the discrimination score will be at a minimum. The updating unit 106 also optimizes the third network so that the cost distance between the first latent variable and the second latent variable will be at a minimum.

Examples of parameters are weight coefficients, bias etc.

For example, the encoder network of the first compressor 101, the decoder network of the generator 102, and the encoder network of the second compressor 103 generates a reconstruction data sample which is indistinguishable from the real data sample, in other words, aims to generate a false data that cannot be differentiated from the real data. Therefore, each parameter should be updated so that the objective function is minimized based on the cost distance between the first latent variable and the second latent variable in the latent space, and a reconstruction loss between the real data sample and reconstruction data sample in the data space.

On the other hand, the discriminative network of the discriminator 104 aims to certainly discriminate the real data sample and the reconstruction data sample. Thus, the parameter of the discriminative network is updated to maximize the objective function based on the discrimination score output from the discriminative network.

Hence, the training which optimizes both the minimization of the object function concerning the encoder network of first compressor 101, the decoder network of generator 102, and the encoder network of the second compressor 103 and maximization of the objective function concerning the discriminative network of the discriminator 104 should be performed.

It is considered that the closer the Manhattan distance between the first latent variable and the second latent variable in the latent space is, the features between the real data sample and the reconstruction data sample will be close; thus, the reconstruction data sample which is the generation source of the second latent variable is also considered to be similar to the real data sample on the data space.

In step S307, the updating unit 106 determines whether the training of each network is finished or not. For instance, determination such as if the training of a predetermined Epoch number is finished or if the training level is stable in the training is made. The training process is finished when the training at each network is finished, and if the training of the network is not finished, the process returns to step S301 and a similar training is repeated.

In the training, four networks described above may be trained jointly to update parameters of each of the networks, or may be trained simultaneously to update the parameters.

Further, in the above example, the training data is trained as all normal data; thus, explicit training of differentiating each data is not performed in the training data. On the other hand, by assigning a label 401 for the training data, training under designated condition may be performed.

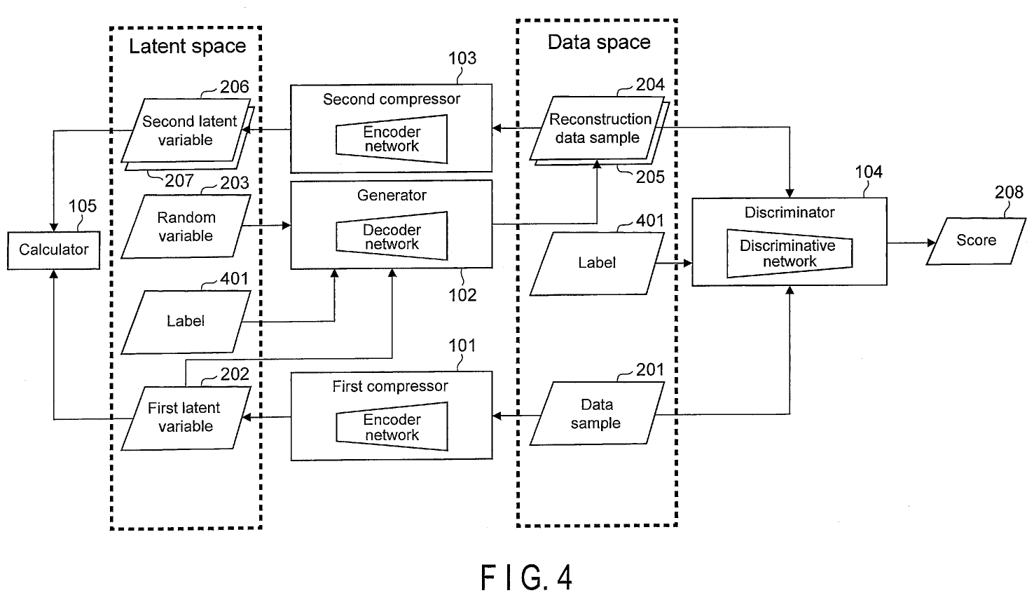

The example of performing training by adding a label 401 to the training data will be explained with reference to the network model of FIG. 4.

The network model of FIG. 4 is similar to the network model shown in FIG. 2: however, differs at the point where the first latent variable 202 and the random variable 203 as well as the label 401 are input to the generator 102, and real data sample 201 and reconstruction data sample 204 along with label 401 are input to the discriminator 104.

The label 401 may be, for example, a one-hot vector concerning the condition to be added. More specifically, by using Modified National Institute of Standards and Technology database (MNIST database) which is an image dataset of handwritten numbers from 0 to 9 which are handwritten input to the training data, assume a case where an image of a handwritten number “3” is input to the first compressor 101 as a real data sample 201. In this case, the one-hot vector which corresponds the numbers 0-9 to ten elements can be used. More specifically, the one-hot vector where the fourth value out of the vector is to be 1 and the others to be 0 (0, 0, 0, 1, 0, 0, 0, 0, 0, 0) can be used.

The input to the decoder network of the generator 102 can be an input of data which combines one-hot vector data having the same label 401 at the end of the vector data of the first latent variable 202 and the random variable 203.

Further, when the real data sample 201 is an image data, the input to the discriminator 104 can be input by two-dimensionally arranging the one-hot vector of the label 401. More specifically, each element of the above one-hot vector is a two-dimensional vector (128×128) showing one image data, and data where fourth two-dimensional vector value being all “1” and other vectors value other than the fourth being all “0” is input to the discriminator 104.

Furthermore, the training method is training that is conducted in a similar step as FIG. 3; and therefore, the explanation will be omitted.

Thus, the training using label 401 allows a training for real data sample, i.e., normal range conditions, and a more detailed classification can be employed.

According to the first embodiment described above, by employing a dual-encoder in generative adversarial network, wherein in particular, the first and second compressors consist of dual-encoder make it possible to GAN minimizing the distance of data sample in the latent space and data space. Moreover, the learning apparatus according to the first embodiment makes it possible to the networks to learn to preserve more information from the real data sample and reduce the bad cycle-consistency.

(A Modification of the First Embodiment)

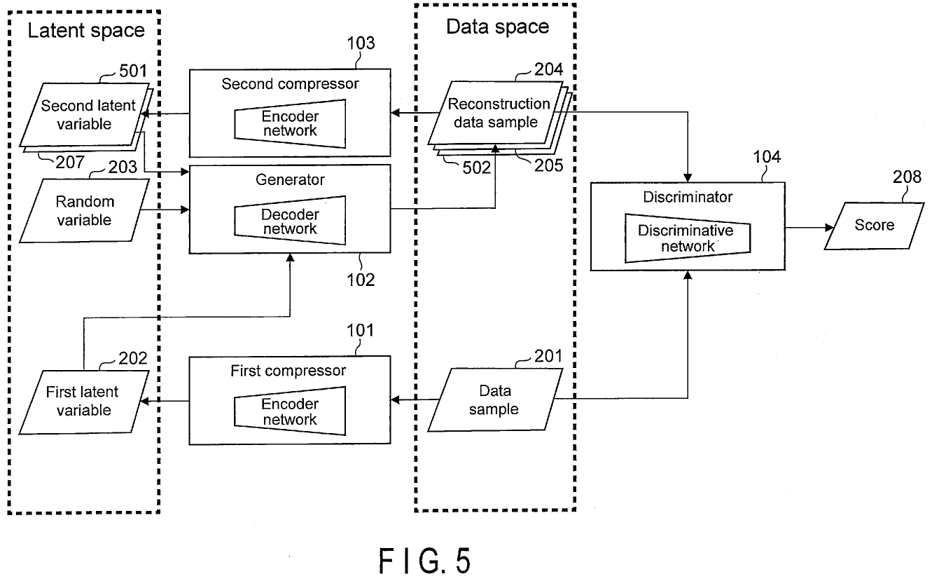

A network model regarding a modification of the first embodiment is described with reference to FIG. 5.

When compared to the network model shown in FIG. 2, the network model shown in FIG. 5 does not include a calculator 105 and differs at the point of the second latent variable 501 being input to the generator 102.

More specifically, first time of training phase, the generator 102 inputs the first latent variable 202 and the random variable 203 to the decoder network, decodes the first latent variable 202 and the random variable 203 to output reconstruction data samples 204 and 205 respectively. And then, the generator 102 also inputs the second latent variable 501 to the decoder network, decodes the second latent variable 501 to output the reconstruction data sample 502 in addition to output of reconstruction data samples 204 and 205.

In this case, the second latent variable 501 to be input is a second latent variable 501 generated by the immediately previous process at second compressor 103.

The second compressor receives the reconstruction data samples 204, 205 and 502. By inputting the reconstruction data samples 204, 205 and 502 into the encoder network, the reconstruction data samples 204 and 502 are encoded and the second latent variable 501 is outputted, and the reconstruction data sample 205 is encoded and the second latent variable 207 is outputted.

the reconstruction data sample 502 is encoded on its own and another second latent variable may be outputted.

For the training, the training of each network is performed by the similar method as the first embodiment aside from not using cost distance calculated by the calculator 105.

According to the modification of the first embodiment, similar to the first embodiment, the bad cycle-consistency can be reduced by optimizing the network to minimize the loss at both latent space and data space.

### Second Embodiment

A second embodiment explains an inference apparatus for performing inference using a trained model trained by the learning apparatus 10 according to the first embodiment.

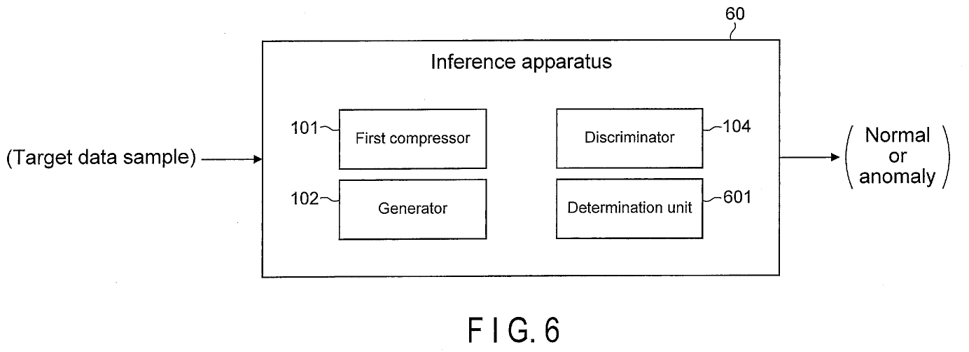

FIG. 6 shows the inference apparatus according to the second embodiment. The inference apparatus 60 includes a first compressor 101, a generator 102, a discriminator 104, and a determination unit 601.

The first compressor 101 generates a latent variable from the target data sample using a trained encoder network.

The generator 102 generates a reconstruction data sample from the latent variable using a trained decoder network.

The discriminator 104 generates a discrimination score regarding a difference of features between a target data sample and the reconstruction data sample using a trained discriminative network. The discrimination score in the second embodiment uses an absolute value of the differences between the features of the target data sample and the features of the reconstruction data sample. In addition, the discriminator 104 calculates a total between the discrimination score and an absolute value of a reconstruction loss in the reconstruction process to the reconstruction image from the target data sample as an anomaly score. Further, weighted addition may be performed on the discrimination score and the reconstruction loss. The determination unit 601 determines whether the target data sample is normal or anomaly based on the anomaly score.

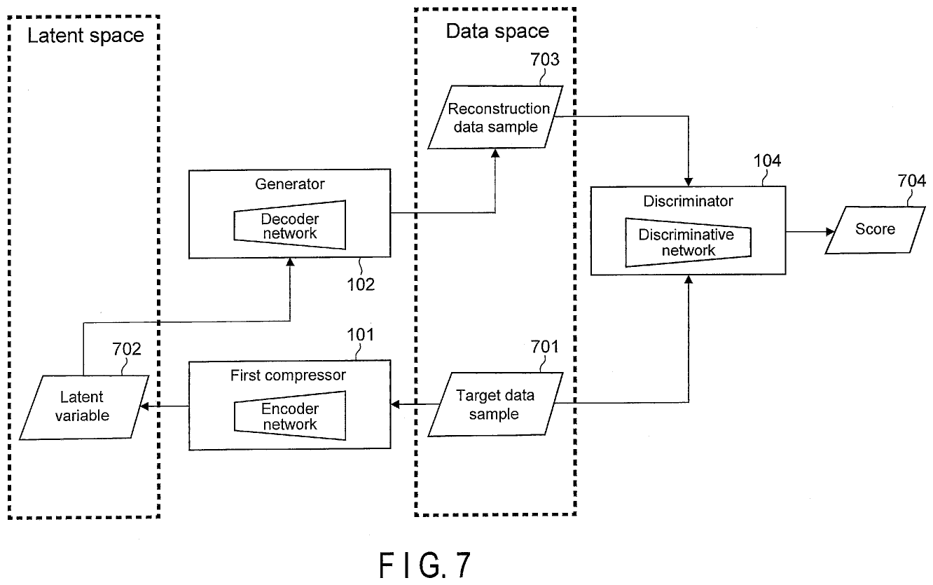

Next, FIG. 7 shows a trained network model used in the inference apparatus 60 according to the second embodiment.

The network model shown in FIG. 7 includes an encoder network of a first compressor 101, a decoder network of a generator 102 and a discriminative network of the discriminator 104.

In the first compressor 101, the target data sample 701 is input to the encoder network and a latent variable 702 is generated.

The generator 102 inputs the latent variable 702 to the decoder network to generate a reconstruction image 703. The decoder network of generator 102 performs a generation process from the latent variable to the reconstruction data sample when the target data sample is a normal value since the training from the latent variable to the real data sample, i.e., the features of the normal data has already been learned by training. In other words, when the target data sample 701 is an anomaly value, the difference between the target data sample and the reconstruction data sample will be caused at the data space.

In the discriminator 104, an examination target data 701 and the reconstruction data sample 703 are input to the discriminative network, the discrimination score is calculated and then the anomaly score 704 is calculated.

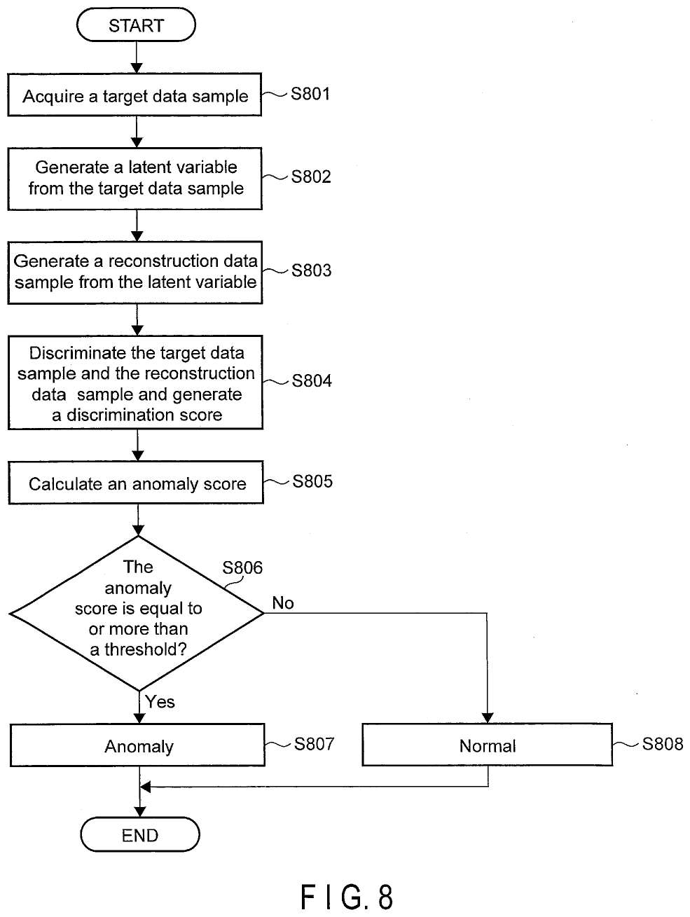

Next, the operation of the inference apparatus 60 according to the second embodiment is explained with reference to the flowchart of FIG. 8.

In step S801, the first compressor 101 obtains the target data sample.

In step S802, the first compressor 101 generates the latent variable from the target data sample using the trained encoder network.

In step S803, the generator 102 generates the reconstruction data sample from the latent variable using the trained decoder network.

In step S804, the discriminator 104 generates the discrimination score by discriminating the target data sample and the reconstruction data sample using the trained discriminative network.

In step S805, the discriminator 104 outputs the total between the discrimination score and the reconstruction loss as the anomaly score.

In step S806, the determination unit 601 determines whether or not the anomaly score is equal to or more than a threshold. If the anomaly score is equal to or more than the threshold, the process proceeds to step S807 and if the anomaly score is below the threshold, the process proceeds to step S808.

In step S807, the determination unit 601 determines that the target data sample is “anomaly”.

In step S808, the determination unit 601 determines that the target data sample is “normal”.

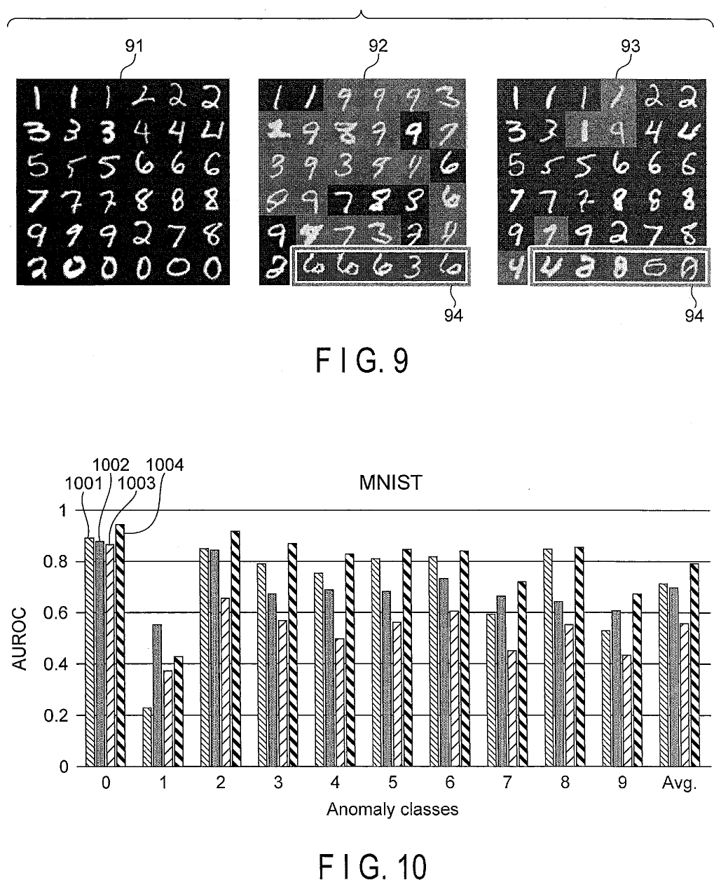

Next, an example of an inference result of the examination target data by the inference apparatus 60 will be explained with reference to FIG. 9.

The left figure of FIG. 9 is a MNIST dataset 91 which is an examination target. In the trained model in the inference apparatus 60, out of the data of examination targets, it is assumed that training is conducted by making an image of handwritten number “0” to be a class of anomaly data, and the images of other handwritten numbers “1-9” to be a class of normal data. Thus, it is assumed that the images of handwritten numbers “1-9” are learned at the network model and the image of handwritten number “0” which does not exist in the training data is discriminated and detected as anomaly data.

The central figure of FIG. 9 is an inference result 92 by a conventional bidirectional GAN(BiGAN) to the MNIST dataset 91 prepared as a comparative evaluation. In FIG. 9, the reconstruction data sample is arranged to correspond to the position of the handwritten numbers of the dataset 91.

In the inference result 92, the anomaly data corresponds to the position of box 94. In other words, it is possible to detect anomaly data when handwritten number 0 is inputted; however, the same number cannot be reconstructed for the majority of inputted data and is greatly affected by the bad cycle-consistency.

On the other hand, the right figure of FIG. 9 is an inference result 93 for the MNIST dataset 91 by the inference apparatus 60 according to the second embodiment. The inference result 93 detects all of the anomaly data positioned in box 94, and compared to the inference result 92, the reconstruction ratio of the same numbers to the inputted data is high. Thus, when the inference result 92 is compared with inference result 93, it is understood at first glance that the inference result 93 of the inference apparatus 60 according to the second embodiment has a reduced impact from the bad cycle-consistency.

Next, the evaluation example of AUROC (Area Under the Receiver Operating Characteristics) metric for each MNIST dataset is explained with reference to FIG. 10.

FIG. 10 shows graph 1004 indicating the performance of the inference apparatus 60 according to the second embodiment, and graphs 1001, 1002, and 1003 show the performance of the other three methods when each of the numbers of 0-9 are to be anomaly numbers.

The vertical axis represents an average of overall performance, i.e., a value of AUROC, horizontal axis represents each number of 0-9. AUROC is one of metrics for evaluating a performance of classification. The higher the value of AUROC is, the better the detection accuracy of anomaly is.

As shown in FIG. 10, when the graph 1004 of the inference apparatus 60 is compared with graphs 1001, 1002, and 1003 of other methods, any number of graph 1004 is higher than the other graphs. Thus, the anomaly detection performance of inference apparatus 60 is higher than other methods.

According to the second embodiment described above, by using the trained model learned by the learning apparatus 10 of the first embodiment, the trained model can generate the reconstruction data sample similar to a normal(real) data sample.

Therefore, high anomaly detection can be realized by inferring to the examination target data, and bad cycle consistency can be greatly improved. This behaviour contributes to high anomaly score of abnormal data sample which increases the ability of the inference apparatus according to the second embodiment to separate the abnormal data sample from the inliers.

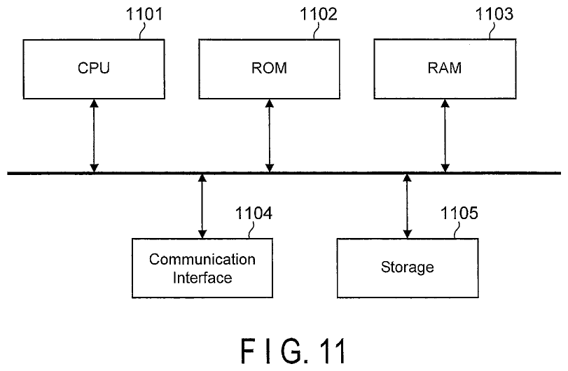

The hardware component of the learning apparatus 10 according to the first embodiment and the inference apparatus according to the second embodiment will be explained with reference to FIG. 11.

The learning apparatus 10 according to the first embodiment and the inference apparatus 60 according to the second embodiment includes a CPU (Central Processing Unit) 1101, a ROM (Read Only Memory) 1102, a RAM (Random Access Memory) 1103, a communication interface 1104, and a storage 1105. Further, each component is connected via bus 1106.

A program executed by the learning apparatus 10 and the inference apparatus 60 according to the present embodiment is downloaded to the computer connected to the network via the Internet, and the computer may function as each component of the learning apparatus 10 and the inference apparatus 60. The downloaded program is stored in ROM 1102 or storage 1105, and the stored program may be read when functioning as each component of the learning apparatus 10 and the inference apparatus 60. In the computer, the CPU 1101 reads and executes the program from a computer readable recording medium on the main storage. As a computer readable recording media, commonly distributed recoding media such as CD-ROM, DVD, Blu-ray (Registered Trademark) Disc etc. may be used.

While certain embodiments have been described, these embodiments have been presented by way of example only, and are not intended to limit the scope of the inventions. Indeed novel methods and systems described wherein may be embodied in a variety of other forms; furthermore various omissions, substitutions and changes in the forms of the methods and systems described herein may be made without departing from the spirit of the inventions. The accompanying claims and their equivalents are intended to cover such forms or modifications as would fall within the scope and spirit of the inventions.

What is claimed is:

1. A learning apparatus, comprising:
a first compressor configured to generate a first latent variable from a data sample using a first network, the first latent variable representing a feature of the data sample in latent space;
a generator configured to generate a reconstruction data sample from the first latent variable using a second network;
a second compressor configured to generate a second latent variable from the reconstruction data sample using a third network;
a calculator configured to calculate a distance in the latent space between the first latent variable and the second latent variable;
a discriminator configured to output a discrimination score relating to a discrimination of the data sample and the reconstruction data sample using a fourth network; and
an updating unit configured to train the first to fourth networks based on the discrimination score and train the third network based on the distance until achieving optimization.

2. A learning apparatus, comprising:
a first compressor configured to generate a first latent variable from a data sample using a first network, the first latent variable representing a feature of the data sample in latent space;
a generator configured to generate a reconstruction data sample from the first latent variable and a second latent variable using a second network;
a second compressor configured to generate, using a third network, the second latent variable from a reconstruction data sample obtained in an immediately previous generation of a reconstruction data sample; and
a discriminator configured to output a discrimination score relating to a discrimination of the data sample and the reconstruction data sample using a fourth network; and
an updating unit configured to train the first to fourth networks based on the discrimination score until achieving optimization.

3. The apparatus according to claim 1, wherein
the updating unit trains the first to fourth networks based on the data sample with a label indicating information of the data sample.

4. The apparatus according to claim 1, wherein the data sample is processed together with latent space variable or random variable to the neural network.

5. The apparatus according to claim 1, wherein the first to fourth neural networks include a plurality of layers and have a hierarchical structure.

6. The apparatus according to claim 5, wherein the plurality of layers are any one of a sequencing structure, a recurrent structure, a recursive structure, a branching structure, or a merging structure.

7. The apparatus according to claim 1, wherein the first to fourth networks are trained simultaneously to update parameters of each of the first to fourth neural networks.

8. The apparatus according to claim 1, wherein the first to fourth neural networks are trained jointly to update parameters of each of the first to fourth neural networks.

9. The apparatus according to claim 1, wherein the data sample is with or without noise.

10. An inference apparatus for performing an inference process using a trained first network, a trained second network and a trained fourth network, comprising:
a compressor configured to generate a latent variable from a target data sample using the trained first network;
a generator configured to generate a reconstruction data sample from the latent variable using the trained second network;
a discriminator configured to output an anomaly score relating to a discrimination of the target data sample and the reconstruction data sample using the trained fourth network; and
a determination unit configured to determine the target data sample being an anomaly when the anomaly score is equal to or more than a threshold value.

11. The apparatus according to claim 10, wherein the data sample and the reconstruction data sample is used a calculation of a reconstruction error.

12. The apparatus according to claim 11, wherein the discriminator
calculates an absolute value of the reconstruction error as a residual score,
calculates an absolute value of a feature difference between the target data sample and the reconstruction data sample as a discrimination score, and
calculate the anomaly score by adding the residual score and the discrimination score.

13. The apparatus according to claim 11, wherein the reconstruction error is used for measuring the anomaly score of an anomaly detection system.

14. A learning method, comprising:
generating a first latent variable from a data sample using a first network, the first latent variable representing a feature of the data sample in latent space;
generating a reconstruction data sample from the first latent variable using a second network;
generating a second latent variable from the reconstruction data sample using a third network;
calculating a distance in the latent space between the first latent variable and the second latent variable;
outputting a discrimination score relating to a discrimination of the data sample and the reconstruction data sample using a fourth network; and
training the first to fourth networks based on the discrimination score and training the third network based on the distance until achieving optimization.

15. A non-transitory computer readable medium including computer executable instructions, wherein the instructions, when executed by a processor, cause the processor to perform a method comprising:
generating a first latent variable from a data sample using a first network, the first latent variable representing a feature of the data sample in latent space;
generating a reconstruction data sample from the first latent variable using a second network;
generating a second latent variable from the reconstruction data sample using a third network;
calculating a distance in the latent space between the first latent variable and the second latent variable;
outputting a discrimination score relating to a discrimination of the data sample and the reconstruction data sample using a fourth network; and
training the first to fourth networks based on the discrimination score and training the third network based on the distance until achieving optimization.
